(19) United States
(12) Patent Application Publication
(10) Pub. No.: US 2025/0061168 A1
(43) Pub. Date: Feb. 20, 2025

(54) COMPUTER-READABLE RECORDING MEDIUM STORING INFORMATION PROCESSING PROGRAM, INFORMATION PROCESSING APPARATUS, AND INFORMATION PROCESSING METHOD

(71) Applicant: Fujitsu Limited, Kawasaki-shi (JP)

(72) Inventor: Yutaka TAMIYA, Yokohama (JP)

(73) Assignee: Fujitsu Limited, Kawasaki-shi (JP)

(21) Appl. No.: 18/776,301

(22) Filed: Jul. 18, 2024

(30) Foreign Application Priority Data
Aug. 17, 2023 (JP) 2023-133111

(51) Int. Cl. G06F 17/11; G06F 9/50

(52) U.S. Cl. CPC G06F 17/11; G06F 9/5027; G06F 2209/506

(57) ABSTRACT

A non-transitory computer-readable recording medium stores a program for causing a computer to execute a process for processing information which includes: obtaining a first nonlinear function to be mapped, calculation accuracy, and an implementation constraint, which are required to implement a nonlinear function in an accelerator; mapping the first nonlinear function to the accelerator to satisfy the calculation accuracy using a predetermined mapping method; determining whether or not a result of the mapping to the accelerator satisfies the implementation constraint; and when the implementation constraint is not satisfied, repeating the mapping and the determining using a mapping method different from the predetermined mapping method.

### CROSS-REFERENCE TO RELATED APPLICATION

This application is based upon and claims the benefit of priority of the prior Japanese Patent Application No. 2023-133111, filed on Aug. 17, 2023, the entire contents of which are incorporated herein by reference.

### FIELD

The embodiment discussed herein is related to a technique for implementing a nonlinear function in an accelerator.

### BACKGROUND

In a high performance computing (HPC) application and a machine learning (ML) application, floating-point calculation of a nonlinear function (exp(x), 1/√x, etc.) is needed. While calculation accuracy required for a calculation result of the nonlinear function differs for each application, it is possible to minimize an amount of circuitry and power consumption by implementing the nonlinear function in a hardware accelerator according to the required calculation accuracy.

International Publication Pamphlet No. WO 2018/066073, International Publication Pamphlet No. WO 2021/100122, U.S. Pat. No. 8,504,954, and U.S. Patent Application Publication No. 2019/0147122 are disclosed as related art.

### SUMMARY

According to an aspect of the embodiments, a non-transitory computer-readable recording medium stores a program for causing a computer to execute a process for processing information which includes: obtaining a first nonlinear function to be mapped, calculation accuracy, and an implementation constraint, which are required to implement a nonlinear function in an accelerator; mapping the first nonlinear function to the accelerator to satisfy the calculation accuracy using a predetermined mapping method; determining whether or not a result of the mapping to the accelerator satisfies the implementation constraint; and when the implementation constraint is not satisfied, repeating the mapping and the determining using a mapping method different from the predetermined mapping method.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating an exemplary configuration of an information processing device 10 according to the present embodiment;

FIG. 2 is a diagram illustrating an exemplary configuration diagram of an implementation process of a nonlinear function according to the present embodiment;

FIG. 3 is a diagram illustrating an exemplary mapping target operation according to the present embodiment;

FIG. 4 is a diagram illustrating exemplary implementation of the nonlinear function using a piecewise polynomial according to the present embodiment;

FIG. 5 is a diagram illustrating exemplary implementation of the nonlinear function using a Newton's method according to the present embodiment;

FIG. 6 is a diagram illustrating exemplary implementation of the nonlinear function using Taylor expansion according to the present embodiment;

FIG. 7 is a diagram illustrating exemplary implementation of the nonlinear function using a Burmann method according to the present embodiment;

FIG. 8 is a diagram illustrating an example of an amount of circuitry and power consumption according to the present embodiment;

FIG. 9 is a flowchart illustrating an exemplary flow of the implementation process of the nonlinear function according to the present embodiment;

FIG. 10 is a flowchart illustrating another exemplary flow of the implementation process of the nonlinear function according to the present embodiment; and

FIG. 11 is a diagram illustrating an exemplary hardware configuration of the information processing device 10 according to the present embodiment.

### DESCRIPTION OF EMBODIMENTS

However, there is a plurality of kinds of methods of implementing the nonlinear function in the accelerator, and the amount of circuitry and the power consumption change depending on the required calculation accuracy. Thus, it needs to select a method of implementing the nonlinear function that further minimizes the amount of circuitry and the power consumption while satisfying the required calculation accuracy.

In one aspect, an object is to more optimally select a method of implementing a nonlinear function in an accelerator.

Hereinafter, examples of an information processing program, an information processing system, and an information processing method according to the present embodiment will be described in detail with reference to the drawings. Note that the present embodiment is not limited by the examples. Furthermore, the individual examples may be appropriately combined within a range without inconsistency.

### [Functional Configuration of Information Processing Device 10]

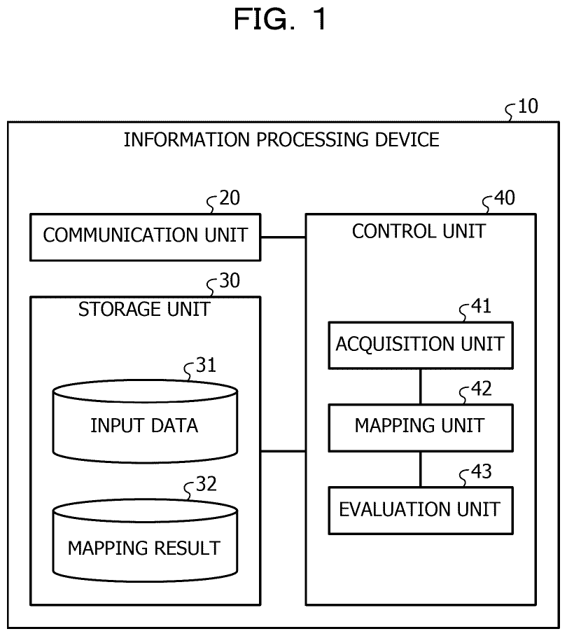

Next, a functional configuration of an information processing device 10 serving as an execution subject of the present embodiment will be described. FIG. 1 is a diagram illustrating an exemplary configuration of the information processing device 10 according to the present embodiment. The information processing device 10 illustrated in FIG. 1 is, for example, an information processing device such as a server computer, a desktop personal computer (PC), a laptop PC, or the like, which is included in an information processing system. Note that, while the information processing device 10 is illustrated as one computer in FIG. 1, it may be a distributed computing system including a plurality of computers. Alternatively, the information processing device 10 may be a cloud computer device managed by a service provider that provides cloud computing services.

As illustrated in FIG. 1, the information processing device 10 includes a communication unit 20, a storage unit 30, and a control unit 40.

The communication unit 20 is a processing unit that controls communication with another device, and is, for example, a communication interface such as a network interface card, or a universal serial bus (USB) interface.

The storage unit 30 has a function of storing various data and programs to be executed by the control unit 40, and stores, for example, input data 31, mapping results 32, and the like.

The input data 31 stores, for example, information regarding a nonlinear function to be mapped, calculation accuracy, and an implementation constraint, which are needed for implementation of the nonlinear function in an accelerator, and the like. Note that the nonlinear function may be, for example, exp(x), 1/√x, erf(x), or the like. Furthermore, the required calculation accuracy may be, for example, single precision (32 bits), double precision (64 bits), or the like. Furthermore, the implementation constraint may be, for example, an amount of circuitry or power consumption, and the amount of circuitry may be the number of processing elements (PEs) as operation units in the accelerator.

The mapping results 32 store, for example, information regarding a mapping result in each mapping method for implementing the nonlinear function in the accelerator, and the like. Note that each mapping method may be, for example, a piecewise polynomial, a Newton's method, Taylor expansion, or a Burmann method (u in Burmann is correctly a letter u with an umlaut mark or dieresis “\ddot{ }”). Furthermore, the mapping result may be, for example, an amount of circuitry or power consumption for each mapping method in the case where the nonlinear function is implemented using each mapping method.

Note that the information to be stored in the storage unit 30 described above is merely an example, and the storage unit 30 may store various types of information other than the information described above.

The control unit 40 is a processing unit that takes overall control of the information processing device 10, and is, for example, a processor or the like. The control unit 40 includes an acquisition unit 41, a mapping unit 42, and an evaluation unit 43. Note that each processing unit is an example of an electronic circuit included in a processor, or an example of a process to be performed by the processor.

For example, the acquisition unit 41 obtains, from the input data 31, a first nonlinear function to be mapped, calculation accuracy (which may be referred to as “required calculation accuracy” hereinafter), and an implementation constraint, which are needed for implementation of the nonlinear function in the accelerator. Note that the first nonlinear function to be mapped, the required calculation accuracy, and the implementation constraint may be stored in the input data 31 in advance, or may be input through an input device when the nonlinear function is implemented in the accelerator and stored in the input data 31.

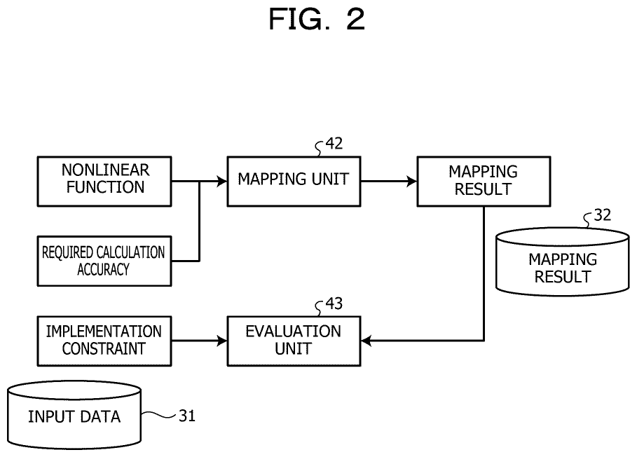

For example, the mapping unit 42 maps the first nonlinear function to the accelerator to satisfy the required calculation accuracy. Note that the mapping here is used in substantially the same meaning as the implementation. FIG. 2 is a diagram illustrating an exemplary configuration diagram of an implementation process of a nonlinear function according to the present embodiment. As illustrated in FIG. 2, for example, the mapping unit 42 uses the nonlinear function and the required calculation accuracy obtained by the acquisition unit 41 as input data, and maps the nonlinear function to the accelerator to satisfy the required calculation accuracy. Furthermore, the mapping unit 42 stores a mapping result in the mapping results 32, for example.

Then, the evaluation unit 43 determines whether or not the implementation constraint is satisfied based on the mapping result, and mapping processing is repeated using another mapping method when the implementation constraint is not satisfied. Thus, the mapping processing includes processing of mapping the first nonlinear function to the accelerator to satisfy the required calculation accuracy using any of the mapping methods of the piecewise polynomial, the Newton's method, the Taylor expansion, and the Burmann method. Furthermore, for example, in the repetitive processing when the implementation constraint is not satisfied, the mapping unit 42 maps the first nonlinear function to the accelerator to satisfy the required calculation accuracy using a mapping method that has not been used. Note that, in terms of the order of using the plurality of kinds of mapping methods, for example, the mapping unit 42 may map the first nonlinear function to the accelerator to satisfy the required calculation accuracy using the mapping methods in predetermined order. Note that the order of using the mapping methods may be, for example, (1) the piecewise polynomial, (2) the Newton's method, (3) the Taylor expansion, and (4) the Burmann method, in ascending order of the amount of circuitry at the time of implementation of the nonlinear function.

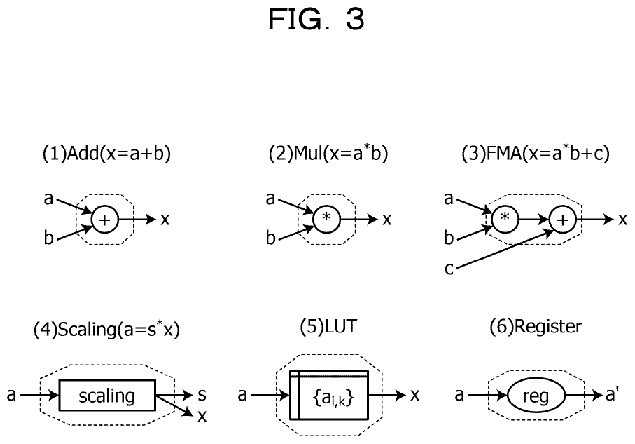

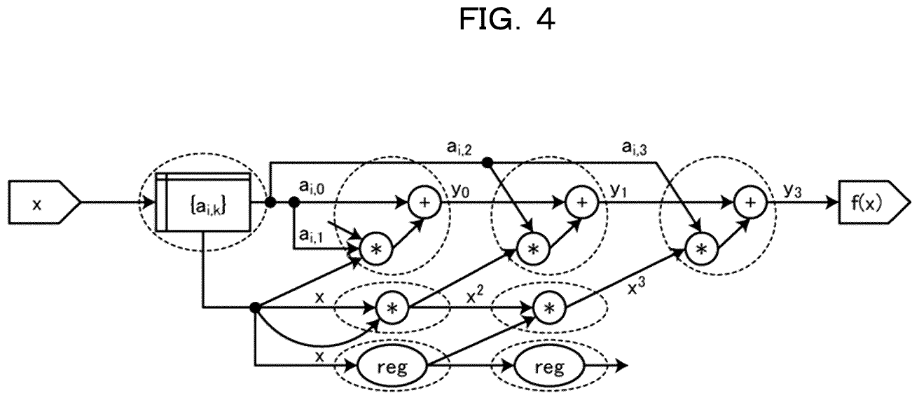

Next, the mapping of the nonlinear function will be more specifically described with reference to FIGS. 4 to 8. FIG. 3 is a diagram illustrating an example of a mapping target operation according to the present embodiment. As illustrated in FIG. 3, the mapping target operation according to the present embodiment is, for example, (1) Add, (2) Mul, (3) FMA, (4) Scaling, (5) LUT, and (6) Register. Add is, for example, binary floating-point addition, and any input may be fixed to a constant. Mul is, for example, binary floating-point multiplication, and any input may be fixed to a constant. FMA is, for example, ternary floating-point addition and multiplication, and any input may be fixed to a constant. Scaling determines scaling s, resolves it as a=s*x, and sets x to fall within a specified range, for example. LUT is what is called a look-up table, and refers to a value for the input a, for example. Register retains an input value, for example. In the present embodiment, an example will be considered in which a processing element (PE) as an operation unit in the accelerator may be mapped to each of such operations. Note that, since each operation surrounded by a broken line in FIG. 3 is one operation unit PE and the amount of circuitry is the number of PEs, for example, the amount of circuitry (the number of PEs) is determined based on how many of the individual operations illustrated in FIG. 3 are included when the nonlinear function is implemented.

First, an exemplary case will be described in which a nonlinear function f(x) is implemented in the accelerator using the piecewise polynomial, which is one of the mapping methods. The piecewise polynomial has the following features. First, the piecewise polynomial switches a coefficient of the polynomial for each section of a value range of the input x, for example. In addition, the piecewise polynomial may be applied to, for example, any nonlinear function. In addition, in the piecewise polynomial, while the degree of the polynomial may be suppressed to 3 when cubic spline interpolation is used, for example, a memory for storing the coefficient is required.

In the example of FIG. 4, the nonlinear function f(x) expressed by the following equation (1) is implemented by the cubic spline interpolation and 256 sections.

$$\begin{matrix}[ Equation 1 ] & \\ f ( x ) ≅ {{a}_{i , 3} ( x - {x}_{i} )}^{3} + {{a}_{i , 2} ( x - {x}_{i} )}^{2} + {a}_{i , 1} ( x - {x}_{i} ) + {a}_{i , 0} , & ( 1 )\end{matrix}$$

where {a_{i,k}} is a set of coefficients for interval xᵢ≤x≤xᵢ₊₁

As indicated in the equation (1), when the piecewise polynomial is used, the degree needed for the polynomial to obtain single precision (32 bits) is 3. Furthermore, when the piecewise polynomial is used, LUT is used to fit polynomial coefficients {a_{j,k}}. The capacity of LUT is 4B*256*4=4 KB with a coefficient of single precision (32 bits).

FIG. 4 is a diagram illustrating exemplary implementation of the nonlinear function using the piecewise polynomial according to the present embodiment. FIG. 4 is an exemplary case where the nonlinear function f(x) expressed by the equation (1) is implemented in the accelerator using the piecewise polynomial. Since the number of operations, for example, the number of PEs is eight as indicated by broken lines in FIG. 4, the mapping result in the case of using the piecewise polynomial is 8 PEs, for example.

Next, an exemplary case will be described in which a nonlinear function 1/√x is implemented in the accelerator using the Newton's method, which is one of the mapping methods. The Newton's method has the following features. First, the Newton's method may be applied to, for example, a differentiable function. In addition, while division is required for the Newton's method, for example, convergence is fast. In addition, the Newton's method is suitable for hardware if it is possible to devise a way of excluding division, for example.

The nonlinear function 1/√x is a solution obtained by solving an equation expressed by the following equation (2) for y.

$$\begin{matrix}[ Equation 2 ] & \\ f = \frac{1}{{y}^{2}} - x = 0 & ( 2 )\end{matrix}$$

When the equation expressed by the equation (2) is solved by the Newton's method, the accuracy is doubled by one recurrence equation as expressed by the following equation (3).

$$\begin{matrix}[ Equation 3 ] & \\ {y}_{n + 1} = \frac{3}{2} {y}_{n} - \frac{x}{2} {y}_{n}^{3} ( = {y}_{n} - \frac{f ( {y}_{n} )}{{f}^{′} ( {y}_{n} )} = {y}_{n} - \frac{{y}_{n}^{- 2} - x}{- 2 {y}_{n}^{- 3}} ) & ( 3 )\end{matrix}$$

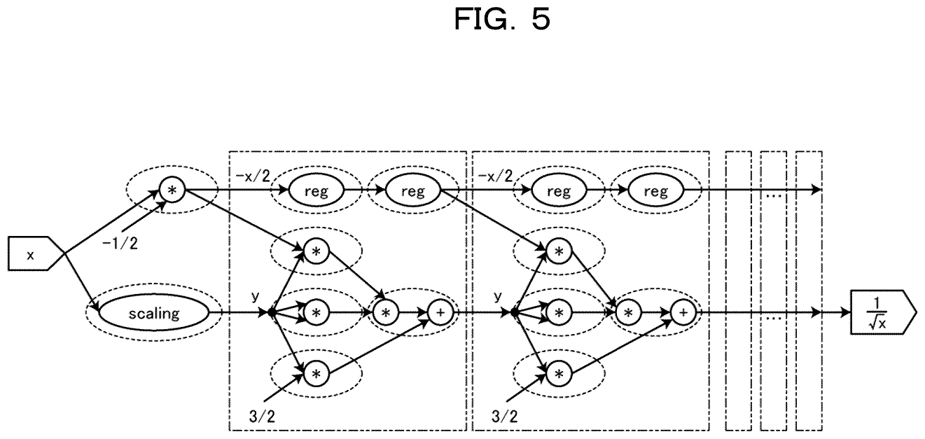

Furthermore, when scaling is carried out such that the initial value has accuracy of 1 bit or more, the accuracy of 32 bits or more may be obtained by five-time repetition. FIG. 5 is a diagram illustrating exemplary implementation of the nonlinear function using the Newton's method according to the present embodiment. FIG. 5 illustrates an exemplary case where the equation expressed by the equation (3) derived by solving the nonlinear function 1/√x is repeated five times to be implemented in the accelerator using the Newton's method. In FIG. 5, a portion surrounded by a dash-dot-dot line is an operation portion for one time of the equation expressed by the equation (3). As indicated by broken lines in FIG. 5, the total number of PEs is 32, which includes 2 for preprocessing and 6×5 times=30 for one time of the equation expressed by the equation (3), and thus the mapping result in the case of using the Newton's method is 32 PEs, for example.

Next, an exemplary case will be described in which a nonlinear function exp(x) is implemented in the accelerator using the Taylor expansion, which is one of the mapping methods. The Taylor expansion has the following features. First, the Taylor expansion may be applied to, for example, a differentiable function. In addition, while the Taylor expansion may be calculated by addition and subtraction, for example, convergence conditions are imposed, and convergence is not fast.

For the nonlinear function exp(x), an equation expressed by the following equation (4) is obtained using the Taylor expansion.

$$\begin{matrix}[ Equation 4 ] & \\ exp ( x ) = 1 + x + \frac{{x}^{2}}{2 !} + \frac{{x}^{3}}{3 !} + … + \frac{{x}^{k}}{k !} + … & ( 4 )\end{matrix}$$

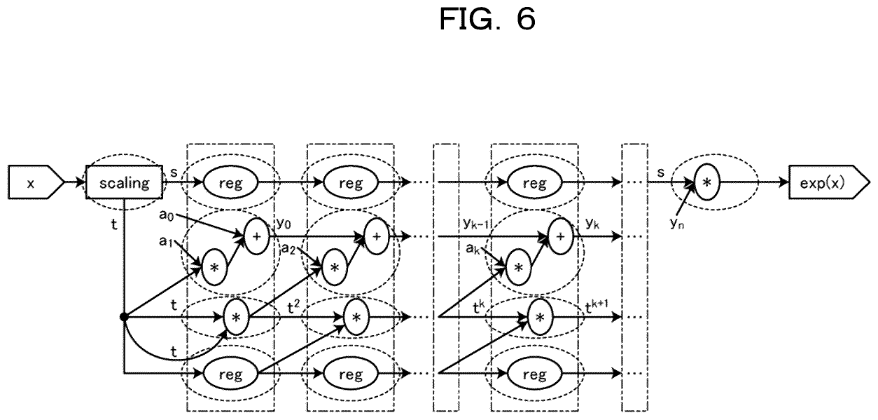

Then, the equation expressed by the equation (4) is mapped. Furthermore, when resolved as x=2^{s}t in the preprocessing, exp(t) may obtain a double-precision value in up to five terms. FIG. 6 is a diagram illustrating exemplary implementation of the nonlinear function using the Taylor expansion according to the present embodiment. FIG. 6 is an example in which exp(t) is mapped using up to five terms. In FIG. 6, a portion surrounded by a dash-dot-dot line is an operation portion for one term of exp(t). As indicated by broken lines in FIG. 6, the total number of PEs is 22, which includes 1 for the preprocessing, 4×5 terms=20 for one term of exp(t), and 1 for postprocessing, and thus the mapping result in the case of using the Taylor expansion is 22 PEs, for example.

Next, an exemplary case will be described in which a nonlinear function erf(x), which is an error function, is implemented in the accelerator using the Burmann method, which is one of the mapping methods. The Burmann method has the following features. First, the Burmann method is known as, for example, a method of calculating the error function erf(x). In addition, while convergence is not fast in the Burmann method, for example, it is faster than the Taylor expansion.

The definition of the error function erf(x) is expressed by the following equation (5).

$$\begin{matrix}[ Equation 5 ] & \\ erf ( x ) = \frac{2}{\sqrt{π}} {\int }_{0}^{x} exp ( - {t}^{2} ) dt & ( 5 )\end{matrix}$$

For the error function, an implementation method based on the Burmann method is known as a special method, and the following equation (6) is obtained for the error function erf(x) using the Burmann method.

$$\begin{matrix}[ Equation 6 ] & \\ erf ( x ) = \frac{2 sgn ( x )}{\sqrt{π}} \sqrt{1 - exp ( - {x}^{2} )} {\sum }_{k = 0}^{∞} {c}_{k} \cdot exp ( - {kx}^{2} ) & ( 6 )\end{matrix}$$

As expressed in the equation (6), in combination with circuits of exp(x) and √x, the Taylor expansion is performed with respect to w=exp(−x²). In this case, up to 20 terms are required to obtain a double-precision value (64 bits). Note that the implementation of √x may be implemented by 32+1=33 PEs, which is obtained by adding one multiplication of 1/√x to the head of the circuit implemented using the Newton's method illustrated in FIG. 5 from √x=x×1/√x.

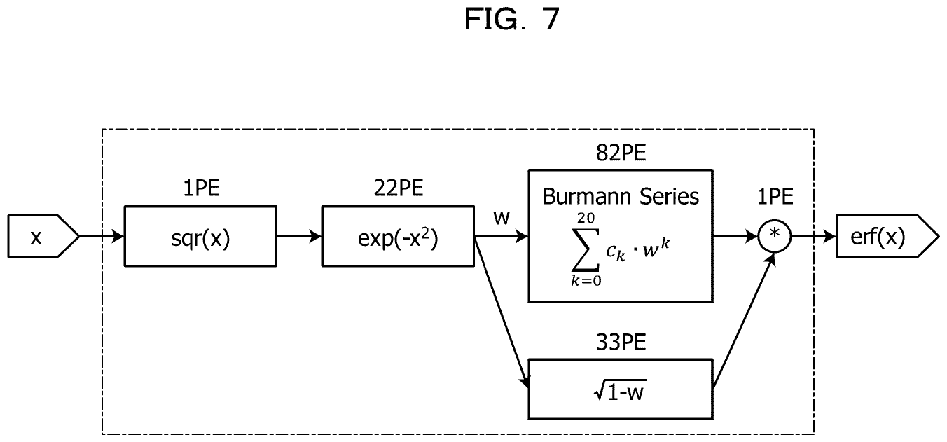

Next, the nonlinear function used in the Burmann method is further implemented using the Newton's method or the Taylor expansion. FIG. 7 is a diagram illustrating exemplary implementation of the nonlinear function using the Burmann method according to the present embodiment. As illustrated in FIG. 7, square calculation of sqr(x) is implemented by 1 PE, and implementation of exp(−x²) is implemented by 22 PEs as t=x². Furthermore, as illustrated in FIG. 7, implementation of V (1−W) is implemented by 33 PEs using the Newton's method. Furthermore, as illustrated in FIG. 7, implementation of a Burmann Series is implemented by 82 PEs as a 20-order polynomial, and the last-stage multiplication is implemented by 1 PE. Since the number of PEs is 1+22+82+33+1=139, the mapping result in the case of using the Burmann method is 139 PEs, for example. Note that, while the number of PEs is larger in the Burmann method than in the piecewise polynomial as described above, implementation based on the Burmann method may be adopted when there is an implementation constraint on the LUT capacity.

Returning to the description of FIG. 1, the evaluation unit 43 determines, for example, whether or not the mapping result to the accelerator satisfies the implementation constraint. As illustrated in FIG. 2, for example, the evaluation unit 43 compares the implementation constraint obtained by the acquisition unit 41 as input data with the mapping result by the mapping unit 42, and determines whether or not the mapping result satisfies the implementation constraint.

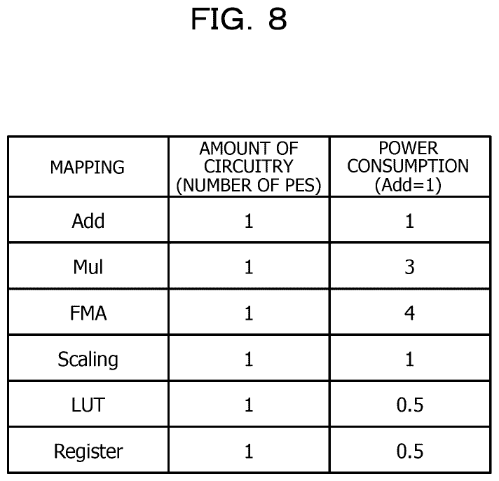

Note that the mapping result is, for example, an amount of circuitry or power consumption when the nonlinear function is implemented, and the evaluation unit 43 determines whether or not the mapping result satisfies the amount of circuitry or power consumption serving as the implementation constraint. FIG. 8 is a diagram illustrating an example of the amount of circuitry and the power consumption according to the present embodiment. As illustrated in FIG. 8, for example, the amount of circuitry and the power consumption are set in advance for each of the mapping target operations. Then, the evaluation unit 43 calculates the sum of the amount of circuitry or the power consumption for the mapping of all the operations at the time of implementation of the nonlinear function using, for example, the amount of circuitry or the power consumption for each mapping target operation set in advance. Next, for example, when the sum of the amount of circuitry or the power consumption is equal to or smaller than the upper limit value given as the implementation constraint, the evaluation unit 43 determines that the calculated sum of the amount of circuitry or the power consumption, for example, the mapping result satisfies the implementation constraint.

Note that, when the implementation constraint is not satisfied, the processing of mapping the nonlinear function performed by the mapping unit 42 and the processing of determining whether or not the implementation constraint is satisfied performed by the evaluation unit 43 are repeated using another mapping method.

Furthermore, the evaluation unit 43 selects one optimal mapping method based on, for example, the calculation accuracy, the amount of circuitry, and the power consumption at the time of implementation of the nonlinear function using each of the mapping methods and the required calculation accuracy and the implementation constraint obtained by the acquisition unit 41. This is to select, as an optimal mapping method, the mapping method with the smallest amount of circuitry or power consumption while the calculation accuracy at the time of implementation of the nonlinear function satisfies the required calculation accuracy, for example.

### [Processing Flow]

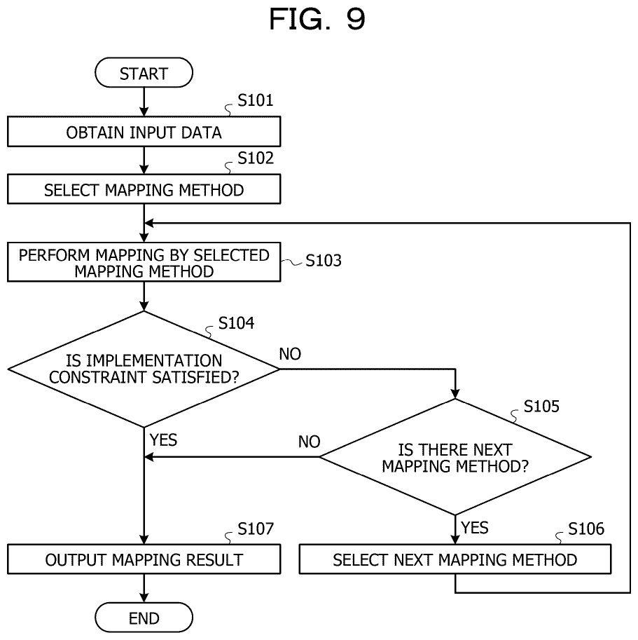

Next, a flow of the implementation process of the nonlinear function in the accelerator according to the present embodiment will be described. FIG. 9 is a flowchart illustrating an exemplary flow of the implementation process of the nonlinear function according to the present embodiment.

First, as illustrated in FIG. 9, the information processing device 10 obtains, from the input data 31, the nonlinear function to be mapped, the required calculation accuracy, and the implementation constraint, which are required when, for example, the nonlinear function is implemented in the accelerator (step S101).

Next, the information processing device 10 selects, for example, a mapping method for mapping the nonlinear function obtained in step S101 (step S102). Note that the order of selecting the mapping methods may be, for example, (1) the piecewise polynomial, (2) the Newton's method, (3) the Taylor expansion, and (4) the Burmann method, in ascending order of the amount of circuitry at the time of implementation of the nonlinear function.

Next, for example, the information processing device 10 maps the nonlinear function to the accelerator to satisfy the required calculation accuracy obtained in step S101 using the mapping method selected in step S102 (step S103).

Next, for example, the information processing device 10 determines whether or not the mapping result of the nonlinear function to the accelerator in step S103 satisfies the implementation constraint obtained in step S101 (step S104).

If it is determined that the mapping result satisfies the implementation constraint (Yes in step S104), the information processing device 10 outputs, for example, the mapping result (step S107). As a result, one mapping method that satisfies the implementation constraint is selected. After the execution of step S107, the implementation process of the nonlinear function illustrated in FIG. 9 is terminated.

On the other hand, if it is determined that the mapping result does not satisfy the implementation constraint (No in step S104) and there is no next mapping method (No in step S105), the information processing device 10 outputs, for example, the mapping result (step S107).

Furthermore, if there is a next mapping method (Yes in step S105), for example, the information processing device 10 selects the next mapping method (step S106), and returns to step S103 to repeat the processing.

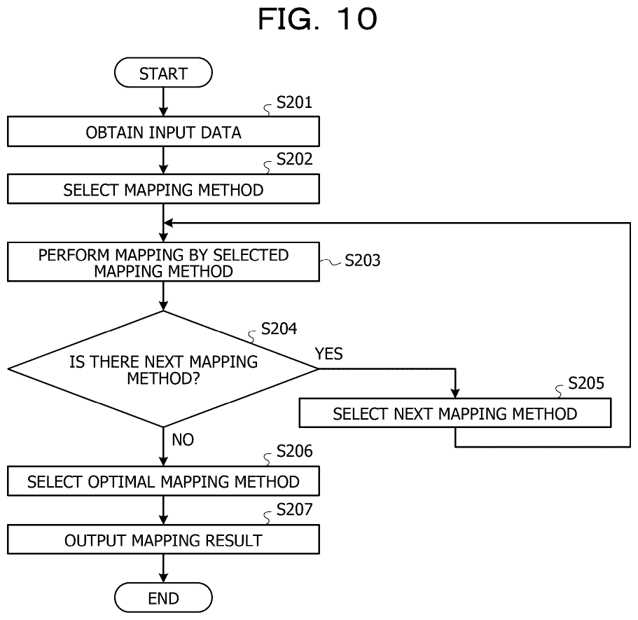

Next, another exemplary flow of the implementation process of the nonlinear function in the accelerator according to the present embodiment will be described. FIG. 10 is a flowchart illustrating another exemplary flow of the implementation process of the nonlinear function according to the present embodiment. In the implementation process of the nonlinear function illustrated in FIG. 9, the process is terminated if the mapping result satisfies the implementation constraint (Yes in step S104), and one mapping method that satisfies the implementation constraint is selected. For example, some mapping methods may not perform mapping or determination as to whether or not the implementation constraint is satisfied. However, another mapping method may be a more suitable mapping method, and thus the implementation process of the nonlinear function illustrated in FIG. 10 is a process for selecting a more optimal mapping method.

Steps S201 to S203 in the implementation process of the nonlinear function illustrated in FIG. 10 are similar to steps S101 to S103 in the implementation process of the nonlinear function illustrated in FIG. 9.

Next, if there is a next mapping method (Yes in step S204), for example, the information processing device 10 selects the next mapping method (step S205), and returns to step S203 to repeat the processing.

On the other hand, if there is no next mapping method (No in step S204), for example, the information processing device 10 selects an optimal mapping method (step S206). For example, the mapping method with the smallest amount of circuitry or power consumption while satisfying the required calculation accuracy is selected based on the calculation accuracy, the amount of circuitry, and the power consumption at the time of mapping by each mapping method and the required calculation accuracy and the implementation constraint obtained in S201.

Next, the information processing device 10 outputs, for example, a mapping result (step S207). After the execution of step S207, the implementation process of the nonlinear function illustrated in FIG. 10 is terminated.

### Effects

As described above, the information processing device 10 obtains the first nonlinear function to be mapped, the calculation accuracy, and the implementation constraint, which are required for implementation of the nonlinear function in the accelerator, maps the first nonlinear function to the accelerator to satisfy the calculation accuracy using a predetermined mapping method, determines whether or not the mapping result to the accelerator satisfies the implementation constraint, and repeats the mapping processing and the determination processing using a mapping method different from the predetermined mapping method when the implementation constraint is not satisfied.

In this manner, the nonlinear function is mapped to the accelerator using the predetermined mapping method, and the processing is repeated using another mapping method when the mapping result does not satisfy the implementation constraint. As a result, the information processing device 10 is enabled to more optimally select a method of implementing the nonlinear function in the accelerator.

Furthermore, the mapping processing executed by the information processing device 10 includes the processing of mapping the first nonlinear function to the accelerator to satisfy the calculation accuracy using any of the mapping methods of the piecewise polynomial, the Newton's method, the Taylor expansion, and the Burmann method.

As a result, the information processing device 10 is enabled to more optimally select a method of implementing the nonlinear function in the accelerator.

Furthermore, the mapping processing executed by the information processing device 10 includes, in the repetitive processing when the implementation constraint is not satisfied, the processing of mapping the first nonlinear function to the accelerator to satisfy the calculation accuracy using a mapping method that has not been used.

As a result, the information processing device 10 is enabled to more optimally select a method of implementing the nonlinear function in the accelerator.

Furthermore, the mapping processing executed by the information processing device 10 includes the processing of mapping the first nonlinear function to the accelerator to satisfy the calculation accuracy using the mapping methods in predetermined order.

As a result, the information processing device 10 is enabled to more optimally select a method of implementing the nonlinear function in the accelerator.

Furthermore, the mapping processing executed by the information processing device 10 includes the processing of mapping the first nonlinear function to the accelerator to satisfy the calculation accuracy using each of the mapping methods, and the information processing device 10 selects one optimal mapping method based on the calculation accuracy and the implementation constraint.

As a result, the information processing device 10 is enabled to more optimally select a method of implementing the nonlinear function in the accelerator.

Furthermore, the determination processing executed by the information processing device 10 includes the processing of determining whether or not the mapping result satisfies the amount of circuitry or the power consumption serving as the implementation constraint.

As a result, the information processing device 10 is enabled to more optimally select a method of implementing the nonlinear function in the accelerator.

### [System]

Pieces of the information including a processing procedure, a control procedure, a specific name, various data, and parameters described above or illustrated in the drawings may be changed in any ways unless otherwise specified. Furthermore, the specific examples, distributions, numerical values, and the like described in the examples are merely examples, and may be changed as appropriate.

Furthermore, specific forms of distribution and integration of the components of the information processing device 10 are not limited to those illustrated in the drawings. For example, the mapping unit 42 of the information processing device 10 may be distributed to a plurality of processing units, or the acquisition unit 41 and the mapping unit 42 of the information processing device 10 may be integrated into one processing unit. For example, all or some of the components may be functionally or physically distributed or integrated in optional units depending on various kinds of loads, use situations, or the like. Moreover, all or any part of the individual processing functions of the individual devices may be implemented by a central processing unit (CPU) and a program analyzed and executed by the CPU, or may be implemented as hardware by wired logic.

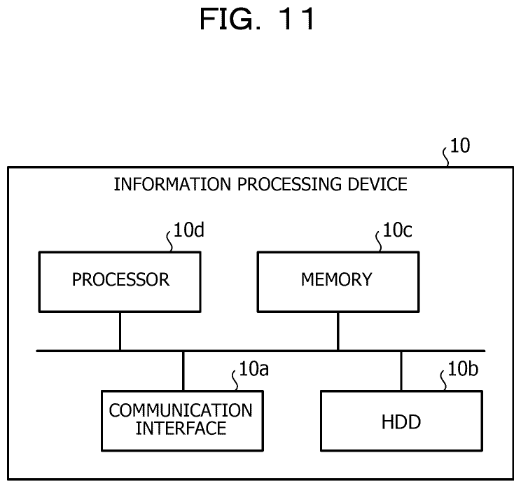

FIG. 11 is a diagram illustrating an exemplary hardware configuration of the information processing device 10 according to the present embodiment. As illustrated in FIG. 11, the information processing device 10 includes a communication interface 10a, a hard disk drive (HDD) 10b, a memory 10c, and a processor 10d. In addition, the individual units illustrated in FIG. 11 are coupled to each other by a bus or the like.

The communication interface 10a is a network interface card or the like, and communicates with another information processing device. For example, when the information processing device is the information processing device 10, the HDD 10b stores programs and data for operating the individual functions illustrated in FIG. 1 and the like.

The processor 10d is a CPU, a micro processing unit (MPU), a graphics processing unit (GPU), or the like. In addition, the processor 10d may be implemented by an integrated circuit such as an application specific integrated circuit (ASIC), a field programmable gate array (FPGA), or the like. The processor 10d reads, from the HDD 10b or the like, a program for performing processes similar to those of the individual processing units illustrated in FIG. 1 and the like, and loads the program into the memory 10c, for example. As a result, the processor 10d is enabled to operate as a hardware circuit that performs a process of implementing each function described with reference to FIG. 1 and the like.

Furthermore, the information processing device 10 may also implement functions similar to those of the examples described above by reading the program described above from a recording medium with a medium reading device and executing the read program described above. Note that the program mentioned in other examples is not limited to being executed by the information processing device 10. For example, the examples described above may be similarly applied to a case where an information processing device other than the information processing device 10 executes the program or a case where the information processing device 10 and another information processing device cooperate to execute the program.

The program may be distributed via a network such as the Internet. Furthermore, the program may be recorded in a computer-readable storage medium such as a hard disk, a flexible disk (FD), a compact disc read only memory (CD-ROM), a magneto-optical disk (MO), a digital versatile disc (DVD), or the like.

Then, the program may be executed by being read from the recording medium by the information processing device 10 or the like.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium storing a program for causing a computer to execute a process for processing information, the process comprising:
obtaining a first nonlinear function to be mapped, calculation accuracy, and an implementation constraint, which are required to implement a nonlinear function in an accelerator;
mapping the first nonlinear function to the accelerator to satisfy the calculation accuracy using a predetermined mapping method;
determining whether or not a result of the mapping to the accelerator satisfies the implementation constraint; and
when the implementation constraint is not satisfied, repeating the mapping and the determining using a mapping method different from the predetermined mapping method.

2. The non-transitory computer-readable recording medium according to claim 1, wherein
the mapping includes mapping the first nonlinear function to the accelerator to satisfy the calculation accuracy using any of mapping methods of a piecewise polynomial, a Newton's method, Taylor expansion, and a Burmann method.

3. The non-transitory computer-readable recording medium according to claim 2, wherein
the mapping includes, in the repeating the mapping and the determining when the implementation constraint is not satisfied, mapping the first nonlinear function to the accelerator to satisfy the calculation accuracy using the mapping method that has not been used.

4. The non-transitory computer-readable recording medium according to claim 2, wherein
the mapping includes mapping the first nonlinear function to the accelerator to satisfy the calculation accuracy using the mapping methods in predetermined order.

5. The non-transitory computer-readable recording medium according to claim 2, wherein
the mapping includes mapping the first nonlinear function to the accelerator to satisfy the calculation accuracy using each of the mapping methods,
the recording medium storing the program for causing the computer to execute the process further comprising:
selecting optimal one of the mapping methods based on the calculation accuracy and the implementation constraint.

6. The non-transitory computer-readable recording medium according to claim 1, wherein
the determining includes determining whether or not the result of the mapping satisfies an amount of circuitry or power consumption that serves as the implementation constraint.

7. An information processing apparatus comprising:
a memory; and
a processor coupled to the memory and configured to:
obtain a first nonlinear function to be mapped, calculation accuracy, and an implementation constraint, which are required to implement a nonlinear function in an accelerator;
map the first nonlinear function to the accelerator to satisfy the calculation accuracy using a predetermined mapping method;
determine whether or not a result of the mapping to the accelerator satisfies the implementation constraint; and
when the implementation constraint is not satisfied, repeat a mapping and the determining using a mapping method different from the predetermined mapping method.

8. The information processing apparatus according to claim 7, wherein
the processor maps the first nonlinear function to the accelerator to satisfy the calculation accuracy using any of mapping methods of a piecewise polynomial, a Newton's method, Taylor expansion, and a Burmann method.

9. The information processing apparatus according to claim 8, wherein
the processor maps, in a process to repeat when the implementation constraint is not satisfied, the first nonlinear function to the accelerator to satisfy the calculation accuracy using the mapping method that has not been used.

10. The information processing apparatus according to claim 8, wherein
the processor maps the first nonlinear function to the accelerator to satisfy the calculation accuracy using the mapping methods in predetermined order.

11. The information processing apparatus according to claim 8, wherein
the processor maps the first nonlinear function to the accelerator to satisfy the calculation accuracy using each of the mapping methods, and
selects optimal one of the mapping methods based on the calculation accuracy and the implementation constraint.

12. The information processing apparatus according to claim 7, wherein
the processor determines whether or not the result of the mapping satisfies an amount of circuitry or power consumption that serves as the implementation constraint.

13. An information processing method for causing a computer to execute a process for processing information, the process comprising:
obtaining a first nonlinear function to be mapped, calculation accuracy, and an implementation constraint, which are required to implement a nonlinear function in an accelerator;
mapping the first nonlinear function to the accelerator to satisfy the calculation accuracy using a predetermined mapping method;
determining whether or not a result of the mapping to the accelerator satisfies the implementation constraint; and
when the implementation constraint is not satisfied, repeating the mapping and the determining using a mapping method different from the predetermined mapping method.

14. The information processing method according to claim 13, wherein
the mapping includes mapping the first nonlinear function to the accelerator to satisfy the calculation accuracy using any of mapping methods of a piecewise polynomial, a Newton's method, Taylor expansion, and a Burmann method.

15. The information processing method according to claim 14, wherein
the mapping includes, in the repeating the mapping and the determining when the implementation constraint is not satisfied, mapping the first nonlinear function to the accelerator to satisfy the calculation accuracy using the mapping method that has not been used.

16. The information processing method according to claim 14, wherein
the mapping includes mapping the first nonlinear function to the accelerator to satisfy the calculation accuracy using the mapping methods in predetermined order.

17. The information processing method according to claim 14, wherein
the mapping includes mapping the first nonlinear function to the accelerator to satisfy the calculation accuracy using each of the mapping methods,
the recording medium storing the program for causing the computer to execute the process further comprising:
selecting optimal one of the mapping methods based on the calculation accuracy and the implementation constraint.

18. The information processing method according to claim 13, wherein
the determining includes determining whether or not the result of the mapping satisfies an amount of circuitry or power consumption that serves as the implementation constraint.
